(19) United States
(12) Patent Application Publication
(10) Pub. No.: US 2025/0249484 A1
(43) Pub. Date: Aug. 7, 2025

(54) REJECTION DEVICE AND ARTICLE INSPECTION DEVICE

(71) Applicant: ANRITSU CORPORATION, Kanagawa (JP)

(72) Inventor: Yuma KINNO, Kanagawa (JP)

(21) Appl. No.: 19/040,812

(22) Filed: Jan. 29, 2025

(30) Foreign Application Priority Data
Feb. 1, 2024 (JP) 2024-014191

(51) Int. Cl. B07C 5/36; B07C 5/28; B65G 43/08; B65G 47/42

(52) U.S. Cl. CPC B07C 5/368; B07C 5/28; B65G 43/08; B65G 47/42

(57) ABSTRACT

A rejection device includes a detection sensor that detects an article, pressurization point setting means for setting an essential pressurization point of the article by using a distance from a front end of the article and a transport time corresponding to a transport speed for each type of the article by a compressed air, a management timer that manages a rejection delay time set by using a delay time from a detection time point when a rear end of the article is detected by a detection sensor to a time point when the essential pressurization point enters a discharge bias section, and rejection command means for inputting a rejection command signal to the rejection unit for a predetermined command time from a time-up time point of the management timer.

### TECHNICAL FIELD

The present invention relates to a rejection device and an article inspection device, and particularly to a rejection device of an air jet type or the like in which articles are required to be discharged in a short time, and an article inspection device in which the rejection device is disposed as a rejection unit on a downstream side of an inspection unit that performs predetermined article inspection.

### BACKGROUND ART

In the related art, an air jet type rejection device is often used as a rejection device that discharges defective articles or the like unsuitable for an article process on a rear stage side in a production line having a small article transport pitch and a high production capacity in a short time.

In addition, an article inspection device is also frequently used in which an air jet type rejection unit that performs a rejection operation according to an inspection result is disposed on a downstream side of an inspection unit that performs the article inspection.

In the related art, as the rejection device and the article inspection device of this type, for example, an article discharge device is known which includes an air jet device that blows air to an estimated centroid position of an article to discharge the article from a line conveyor, a transport state detection device that detects a transport state of the article by a light emitter and receiver, and a control unit that controls the air jet device, in which the control unit discharges the article, which is unsuitable for a box packaging process on a rear stage side, from the air jet device by blowing air from the air jet device on the line conveyor when detecting that a degree of inclination of the article with respect to a transport direction is equal to or greater than a certain level based on a change in light shielding time of the light emitter and receiver, and calculates a time until the estimated centroid position of the article detected at a front end reaches a front of an air nozzle in accordance with the inclination with respect to the transport direction during the discharge (for example, refer to Patent Document 1).

### RELATED ART DOCUMENT

### Patent Document

[Patent Document 1] JP-A-2010-179969

### DISCLOSURE OF THE INVENTION

### Problem That the Invention is to Solve

However, in the rejection device and the article inspection device in the related art as described above, in order to suppress the occurrence of inclination or displacement with respect to the transport direction of the articles before and after while reliably discharging the discharge target article, the timing of blowing air to the discharge target article is set such that air is blown toward the estimated centroid position of the discharge target article.

Therefore, the time for blowing air is limited to a short time, and thus there is a problem that not only fine setting using a setting screen is required so that the blowing of air does not deviate from the estimated centroid position, but also a discharge direction of the discharged article is likely to be unstable.

On the other hand, it is conceivable to use a pusher type discharge mechanism unit that pushes the discharge target article in a direction orthogonal to the transport direction, but in a production line having a small article transport pitch, there is a problem that an article transport speed is limited to a relatively low speed due to the need to reciprocate a pusher plate between a retraction standby position and a push-out completion position, which causes a decrease in productivity.

In addition, it is also conceivable to increase an air nozzle width, in the production line in which the article transport pitch is small, but there is a problem that there is an adverse effect on a transport posture or the like of the articles before and after, or an adverse effect on a weight measurement unit in the previous stage.

Therefore, an object of the present invention is to provide a rejection device and an article inspection device capable of easily and accurately setting a blowing timing of air for biasing a transport article of a discharge target in a discharge direction from a side surface and capable of stably performing a discharge operation of the article without reducing productivity.

### Means for Solving the Problem

In order to achieve the above object, a rejection device according to a first aspect of the present invention including a transport unit that transports an article and includes a rejection transport passage, and a discharge mechanism unit that responds to an input of a rejection command signal and discharges the article, which enters a specific discharge bias section in the rejection transport passage, to an outside of the rejection transport passage by compressed air, the rejection device including: a rejection article detection sensor that is disposed on an entrance side of the rejection transport passage and detects the article; pressurization point setting means for setting an essential pressurization point of the article when a discharge force to the outside of the rejection transport passage is applied from the discharge mechanism unit by the compressed air, based on a transport time corresponding to a distance and a transport speed from any one end of the article in a transport direction for each type of the article; delay time management means for managing a rejection delay time that is set by using a delay time from a detection time point when the one end of the article in the transport direction is detected by the rejection article detection sensor to a time when the essential pressurization point of the article enters the discharge bias section, and; rejection command means for inputting the rejection command signal to the discharge mechanism unit for a predetermined command time from a time-up time point of the delay time management means.

With this configuration, the essential pressurization point of the article is set in advance in association with the information on the article type as the transport time corresponding to the distance and transport speed in the transport direction from any one end of the article in the transport direction. Then, when a rejection delay time that is set using a delay time from a detection time point when any one end of the article to be discharged is detected by the rejection article detection sensor to a time when the essential pressurization point of the article enters the discharge bias section elapses, the delay time management means is timed up (means the time is over), and the rejection command means inputs the rejection command signal to the discharge mechanism unit for a predetermined command time from that time point. Therefore, it is a rejection device in which in a case where the centroid position of the discharge target article is biased in the specific direction with respect to the center of the length in the transport direction based on the detection information of the rejection article detection sensor, in a case where the pressure receiving center position of the discharge force (wind pressure load) due to the blowing of the compressed air is biased in the specific direction from the center of the length in the transport direction, or the like, the essential pressurization point at which the bias direction and the adjustment amount of the minimum timing can be specified is set. Therefore, the timing of blowing air for biasing the transport article of the discharge target to the discharge direction from the side surface can be easily and accurately set, and the stable discharge operation of the article can be performed without reducing the productivity.

The minimum adjustment amount mentioned herein may be set as a minimum adjustment time suitable for stepwise adjustment of the blowing timing of the compressed air, and in this case, it can be set just by specifying the direction in a case where the bias of the centroid clearly occurs depending on the type of the article. Of course, it is also possible to be set in the essential pressurization point that is converted in the number of multiple times the minimum adjustment time based on the centroid of the net product in the container such as a packaging box, or the essential pressurization point that is an optimal calculation value. In addition, in a case where the pressure receiving center point of the wind pressure from the side is deviated from the center of the length in the transport direction based on the detection information of the rejection article detection sensor in the appearance of the article, the discharge force may be stably secured by effectively applying the wind pressure by setting the essential pressurization point to the pressure receiving center side of the wind pressure.

A rejection device according to a second aspect of the present invention is the rejection device according to the first aspect, in which the one end of the article in the transport direction is a rear end of the article in the transport direction, the delay time management means manages a rejection delay time set by using a delay time from a detection time point when the rear end of the article in the transport direction is detected by the rejection article detection sensor to a time when the essential pressurization point of the article enters the discharge bias section in the rejection transport passage, and the rejection command means controls the command time of the rejection command signal in accordance with an article length corresponding time from a first detection time point when a front end of the article in the transport direction is detected by the rejection article detection sensor to a second detection time point when the rear end of the article in the transport direction is detected by the rejection article detection sensor. In this case, the command time of the rejection command signal can be accurately controlled according to the article size.

A rejection device according to a third aspect of the present invention is the rejection device according to the first aspect, in which the article stores a predetermined-shaped net product in a predetermined-shaped packaging box or other containers, the net product having a weight greater than a weight of the container, and a centroid of the net product is deviated from a center position of the article in the transport direction, and the pressurization point setting means sets the essential pressurization point of the article to be closer to a centroid position side of the net product in an article length than a center of the article length in the transport direction. In addition, a rejection device according to a fourth aspect of the present invention is the rejection device according to the second aspect, in which the article stores a predetermined-shaped net product in a predetermined-shaped packaging box or other containers, the net product having a weight greater than a weight of the container, and a centroid of the net product is deviated from a center position of the article in the transport direction, and the pressurization point setting means sets the essential pressurization point of the article to be closer to a centroid position side of the net product in the article length than a center of the article length in the transport direction.

With such a configuration, the pressurization point setting means specifies, as the position information of the essential pressurization point, a direction in which the centroid of the net product is deviated with respect to the apparent centroid of the article based on the detection information of the rejection article detection sensor. Therefore, at least the direction in which the timing of the blowing of the compressed air with respect to the apparent centroid of the article is to be adjusted is specified, and the blowing timing of the air biasing the transport article of the discharge target in the discharge direction from the side surface can be easily and accurately set.

A rejection device according to a fifth aspect of the present invention is the rejection device according to the first aspect, in which a diagram center position of a projection diagram of the article as viewed in a discharge bias direction by the compressed air from the discharge mechanism unit is deviated from a center position of the article in the transport direction, and the pressurization point setting means sets the essential pressurization point of the article to be closer to a diagram center position side of a projection plane shape as viewed in the discharge bias direction than a center of an article length in the transport direction. In addition, a rejection device according to a sixth aspect of the present invention is the rejection device according to the second aspect, in which a diagram center position of a projection diagram of the article as viewed in a discharge bias direction by the compressed air from the discharge mechanism unit is deviated from a center position of the article in the transport direction, and the pressurization point setting means sets the essential pressurization point of the article to be closer to a diagram center position side of a projection plane shape as viewed in the discharge bias direction than a center of the article length in the transport direction.

With such a configuration, in a case where the position of the pressure receiving center point of the wind pressure with respect to the apparent centroid of the article based on the detection information of the rejection article detection sensor, that is, the diagram center position of the projection diagram as viewed in the discharge bias direction of the article is deviated, the essential pressurization point setting means can specify the direction in which the diagram center position is deviated by the position information of the essential pressurization point. Therefore, at least the direction in which the timing of the blowing of the compressed air with respect to the apparent centroid of the article is to be adjusted is specified, and the blowing timing of the air biasing the transport article of the discharge target in the discharge direction from the side surface can be easily and accurately set. The case mentioned here that the diagram center position of the projection diagram as viewed in the discharge bias direction of the article is deviated from the apparent centroid typically refers to, for example, a case where one end portion on the lower surface side of the article during transport protrudes with holes to form a hanging hook or a gripping function.

A rejection device according to a seventh aspect of the present invention is the rejection device according to the first aspect, in which the delay time management means has an encoder that detects a rotational angle displacement of a transport driving motor driving the transport unit in a predetermined angle unit and outputs a detection pulse for each predetermined angle, and a count circuit that counts an output pulse of the encoder and inputs a detection signal of the rejection article detection sensor, and the rejection delay time is grasped based on a count value of the output pulse of the encoder after the detection time point when the one end of the article in the transport direction is detected by the rejection article detection sensor. In addition, a rejection device according to an eighth aspect of the present invention is the rejection device according to the second aspect, in which the delay time management means has an encoder that detects a rotational angle displacement of a transport driving motor driving the transport unit in a predetermined angle unit and outputs a detection pulse for each predetermined angle, and a count circuit that counts an output pulse of the encoder and inputs a detection signal of the rejection article detection sensor, and the rejection delay time is grasped based on a count value of the output pulse of the encoder after the detection time point when the one end of the article in the transport direction is detected by the rejection article detection sensor.

Even in this way, the detection can be performed from the time point of the article detection by the rejection article detection sensor based on the encoder output pulse for detecting the rotational angle displacement of the transport driving motor, the rejection delay time can be calculated based on the encoder output as the article transport distance/transport speed corresponding thereto, and the rejection delay time can be managed based on the transport distance.

A ninth aspect of the present invention relates to an article inspection device including: a transport unit that transports an article and includes a predetermined transport passage; an inspection unit that inspects a predetermined quality state of the article being transported in a predetermined inspection section in the transport passage; an air jet type discharge mechanism unit that responds to an input of a rejection command signal and discharges an article which is inspected in a predetermined rejection section in the transport passage to an outside of the transport passage in accordance with an inspection result in the inspection unit; and a control unit that includes an inspection control unit controlling the inspection unit and a rejection control unit controlling the discharge mechanism unit, in which the discharge mechanism unit includes a rejection article detection sensor that is disposed on an entrance side of the predetermined rejection section, pressurization point setting means for setting an essential pressurization point of the article when a discharge force to the outside of the transport passage is applied from the discharge mechanism unit by compressed air, based on a transport time corresponding to a distance and a transport speed from any one end of the article in a transport direction for each type of the article, delay time management means for managing a rejection delay time that is set by using a delay time from a detection time point when the one end of the article in the transport direction is detected by the rejection article detection sensor to a time when the essential pressurization point of the article enters a discharge bias section, and, rejection command means for inputting the rejection command signal to the discharge mechanism unit for a predetermined command time from a time-up time point of the delay time management means in accordance with an inspection result in the inspection unit.

With this configuration, the essential pressurization point of the article is set in advance in association with the information on the article type as the transport time corresponding to the distance and transport speed in the transport direction from any one end of the article in the transport direction. Then, when the rejection delay time that is set using the delay time from the detection time point when any one end of the article to be discharged is detected by the rejection article detection sensor to a time when the essential pressurization point of the article enters the discharge bias section elapses, the delay time management means is timed up, and the rejection command means inputs the rejection command signal to the discharge mechanism unit for a predetermined command time from that time point. Therefore, in a case where the centroid position of the discharge target article is biased in the specific direction with respect to the center of the length in the transport direction based on the detection information of the rejection article detection sensor, in a case where the pressure receiving center position of the discharge force (wind pressure load) due to the blowing of the compressed air is biased in the specific direction from the center of the length in the transport direction, or the like, the essential pressurization point at which the bias direction and the adjustment amount of the minimum timing can be specified is set. Therefore, the timing of blowing air for biasing the transport article of the discharge target in the discharge direction from the side surface can be easily and accurately set, and the article inspection device capable of performing a stable discharge operation of the article is obtained.

A tenth aspect of the present invention relates to the article inspection device according to the ninth aspect, in which the one end of the article in the transport direction is a rear end of the article in the transport direction, the delay time management means manages a rejection delay time set by using a delay time from a detection time point when the rear end of the article in the transport direction is detected by the rejection article detection sensor to a time when the essential pressurization point of the article enters the discharge bias section in the transport passage, and the rejection command means controls the command time of the rejection command signal in accordance with an article length corresponding time from a first detection time point when a front end of the article in the transport direction is detected by the rejection article detection sensor to a second detection time point when the rear end of the article in the transport direction is detected by the rejection article detection sensor. In this case, the command time of the rejection command signal can be accurately controlled according to the article size.

### Advantage of the Invention

According to the present invention, it is possible to provide a rejection device and an article inspection device capable of easily and accurately setting a blowing timing of air for biasing the transport article of the discharge target in the discharge direction from the side surface and capable of stably performing the discharge operation of the article without reducing productivity.

### BRIEF DESCRIPTION OF THE DRAWINGS

FIG. 1 is an explanatory diagram of a rejection control timing illustrated together with a corresponding control signal waveform in a schematic configuration diagram of an article inspection device including a rejection device according to an embodiment of the present invention.

FIG. 2 is a schematic configuration diagram of a weight checking type article inspection device including an air jet type rejection device according to an embodiment of the present invention.

FIG. 3 is a plan configuration view of a main part of an article inspection device including a rejection device according to an embodiment of the present invention.

FIG. 4 is a schematic block configuration diagram of a control unit of a weight checking type article inspection device including a rejection device according to an embodiment of the present invention.

FIG. 5 is a timing chart illustrating a change in a signal of each unit of a control unit of the article inspection device including the rejection device according to an embodiment of the present invention.

FIGS. 6A to 6D are explanatory diagrams of a setting example which is focused on a centroid of an essential pressurization point for a plurality of types of articles as an inspection target in the article inspection device including the rejection device according to an embodiment of the present invention.

FIGS. 7A to 7C are explanatory diagrams of a setting example which is focused on a pressure receiving center of wind pressure of an essential pressurization point for a plurality of types of articles as an inspection target in the article inspection device including the rejection device according to an embodiment of the present invention.

FIG. 8 is an explanatory diagram of a modified aspect in which a rejection delay time is managed on a transport distance basis in the article inspection device including the rejection device according to an embodiment of the present invention.

### BEST MODE FOR CARRYING OUT THE INVENTION

Hereinafter, embodiments according to the present invention will be described with reference to the drawings.

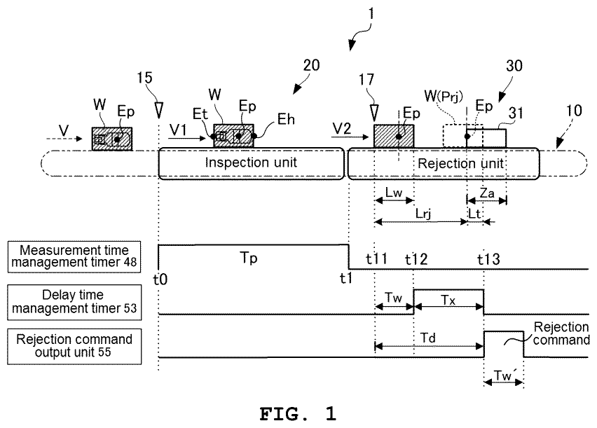

FIGS. 1 to 7C illustrate an article inspection device according to an embodiment of the present invention.

First, a configuration thereof will be described.

As illustrated in FIGS. 1 to 4, an article inspection device 1 of the present embodiment is a weight checking type article inspection device including a transport unit 10 that transports an article W in a predetermined transport passage, an inspection unit 20 that inspects a predetermined quality state of the article W, for example, an adequacy of a net weight by weight measurement in a predetermined inspection section Z1 in the transport passage, a rejection unit 30 that operates in accordance with an input of a rejection command signal and performs a rejection operation of the inspected article W inspected by the inspection unit 20 in accordance with an inspection result thereof, and a control unit 40 that controls the transport unit 10, the inspection unit 20, and the rejection unit 30.

The transport unit 10 is configured of a plurality of conveyor units 11, 12, 13, and 14 disposed in a row in a right-left direction in FIG. 1 and transport driving means thereof, and the conveyor units 11 to 14, which are not illustrated in detail, support a plurality of loop-shaped conveyor belts to be capable of being driven for transport by a plurality of rollers on a driving side and a driven side that are parallel to each other, respectively, so that the article W can be sequentially transported in a right direction in FIG. 1. In addition, the transport driving means of the plurality of conveyor units 11, 12, 13, and 14 is configured with a motor for transport driving, an encoder for detecting a speed of the motor, and the like, and is controlled by the control unit 40 so as to have a transport speed set for each type of the article W.

The inspection unit 20 includes a weighing table 21 that supports the conveyor unit 12 and a weighing unit 22 that measures a load applied from the weighing table 21 by an electromagnetic balance scale or a load cell scale, and is able to output a weight measurement signal corresponding to the weight of the article W from the weighing unit 22 to a control unit 40 side. Here, although the weighing table 21 and the weighing unit 22 are schematically illustrated, it is needless to say that the disposition and the number of the weighing table 21 and the weighing unit 22, the conditions for weight measurement, and the like are not particularly limited. In addition, here, although the inspection unit 20 is assumed to be capable of measuring the weight of the article W, it is obvious that the inspection unit 20 may be an inspection unit of another article inspection method.

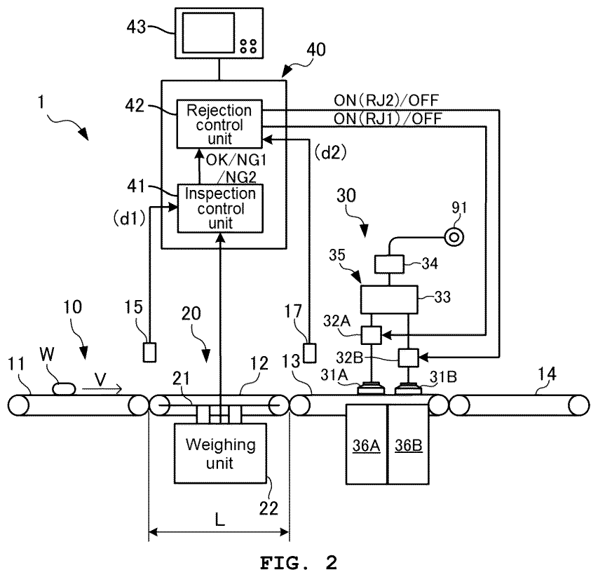

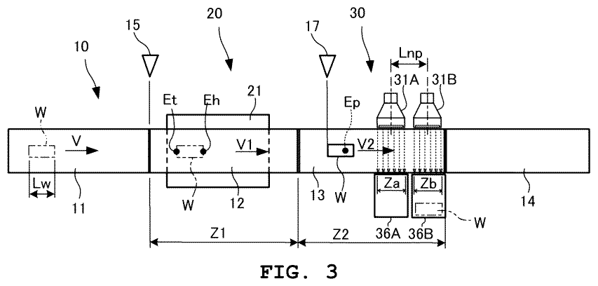

As illustrated in FIGS. 2 and 3, the rejection unit 30 includes air nozzles 31A and 31B that are disposed to be spaced apart from each other so as to be directed substantially in the same direction on one side of the conveyor unit 13 in a transport passage width direction and to have a predetermined inter-nozzle pitch Lnp in the transport direction, an air supply control mechanism unit 35 that selectively supplies compressed air to both the air nozzles 31A and 31B, and chutes 36A and 36B that collect a plurality of discharged and fallen articles corresponding to the air nozzles 31A and 31B.

Each of the air nozzles 31A and 31B is, for example, a flat type having one or a plurality of blowing ports, but may be a type in which a plurality of small-diameter pores or slits are disposed in a row to be spaced apart from each other at a predetermined pitch in the transport direction, or a type in which a plurality of pores or slits are disposed in a plurality of rows to be spaced apart from each other at each of the arrangement pitches in the transport direction and a height direction.

The air nozzles 31A and 31B may be disposed on both sides of the conveyor unit 13 in the transport passage width direction such that the blowing directions of the compressed air from the respective blowing ports intersect with each other. In addition, in a case where a jetting angle of each of the air nozzles 31A and 31B is, for example, greater than 0 degrees (straight) and less than 30 degrees, the air nozzles 31A and 31B may be disposed in a form such that central axis lines of the respective air nozzles 31A and 31B are inclined to a downstream side in the transport direction with an inclination angle of about ½ or less of the jetting angle.

The air supply control mechanism unit 35 is configured to include electromagnetic valves 32A and 32B of one side and the other side connected to the air nozzles 31A and 31B of one side and the other side, an air tank 33 that communicates with the corresponding air nozzle 31A or/and 31B via the electromagnetic valve 32A or/and 32B during being opened when any one or both of the electromagnetic valves 32A and 32B are opened, and a filter regulator 34 that filters air (compressed air) from an air source 91 with predetermined quality and controls the air to a set pressure.

The rejection unit 30 is a discharge mechanism unit that discharges the article W that has entered a specific discharge bias section Za or/and Zb on the conveyor unit 13 forming the rejection section Z2 (rejection transport passage) to the outside of the rejection transport passage by compressed air jetted from the corresponding air nozzle 31A or/and 31B through an electromagnetic valve 32A or/and 32B during being opened in response to the input of the rejection command signal from the rejection control unit 42.

An inspection article detection sensor 15 that detects the carrying-in article W onto the conveyor unit 12 is disposed near an upstream end of the conveyor unit 12, which is an entrance side of the predetermined inspection section Z1 of the inspection unit 20, and a rejection article detection sensor 17 that detects the article W that is capable of being rejected and is carried in onto the conveyor unit 13 is disposed near the upstream end of conveyor unit 13 of the rejection unit 30 on the downstream side of the predetermined inspection section Z1, that is, the entrance side of the rejection section Z2 in FIG. 3. Both the inspection article detection sensor 15 and the rejection article detection sensor 17 are configured of, for example, a light emitting and receiving type photoelectric sensor in which light emitted from a light emitting element is received by a light receiving element, and are configured to detect the article when the article W is shielded between the light emitter and receiver. Both the article detection sensors 15 and 17 are not limited to the optical sensors, and may be, for example, sensors that detect a timing at which the article W reaches a predetermined position from a camera image including an indicator of a reference position and an image of the article, and the transport speed.

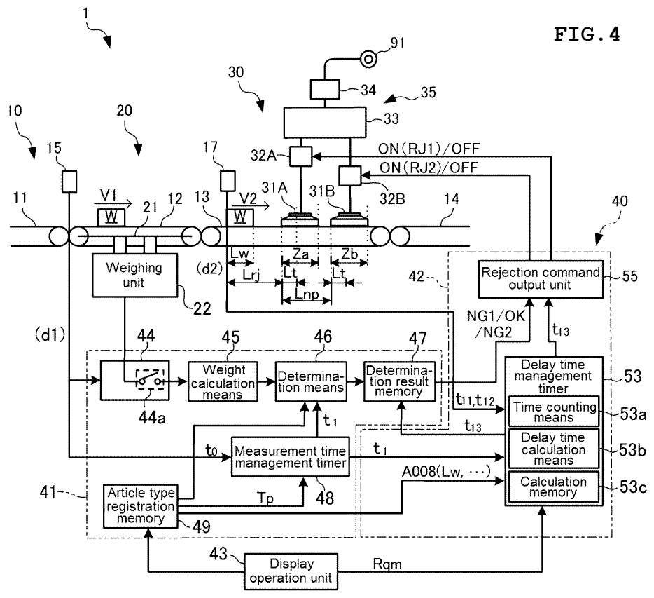

As illustrated in FIGS. 2 and 4, the control unit 40 is configured to include an inspection control unit 41, a rejection control unit 42, and a display operation unit 43, and the weight measurement signal output from the weighing unit 22 is taken in by the inspection control unit 41 to perform predetermined measurement and inspection process. In addition, an input operation or a result confirmation of an operator is performed by the display operation unit 43.

The control unit 40 has a computer configuration including a CPU, a ROM, a RAM, and an I/O interface, and includes, for example, a programmable controller that provides input/output signals to various drivers for driving. Of course, the hardware configuration of the control unit 40 is not limited to a specific form, and software including a plurality of control programs, control parameters, and the like for exhibiting functions necessary for the inspection and rejection of the article W is also not limited to a specific form.

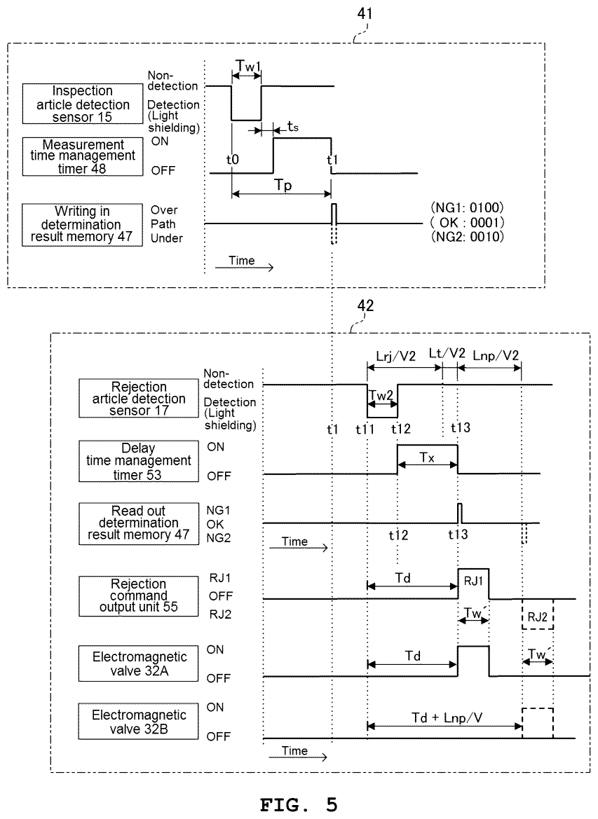

As illustrated in FIGS. 4 and 5, the predetermined measurement and inspection process in the inspection control unit 41 is a process that determines whether the measurement weight of the article W based on the weight measurement signal from the weighing unit 22 is within an allowable range, in an over side out of the allowable range, or in an under side below the allowable range, and outputs an OK signal, an NG1 signal, or an NG2 signal when a predetermined inspection time Tp (measurement time) elapses from the carry-in detection time point to by the inspection article detection sensor 15, and the inspection control unit 41 has a plurality of measurement and inspection processing programs for exhibiting the processing function.

In addition, when a transport time Tw (refer to FIG. 1) elapses corresponding to an article length from a time point t11 (hereinafter, also referred to as a first detection time point) at which a rejection article detection sensor 17 is shielded by the article W to be rejected and a front end Eh of the article W is detected to the time point t12 (hereinafter, also referred to as a second detection time point) at which the light shielding state of the rejection article detection sensor 17 is released and the rear end Et of the article W is detected, the rejection control unit 42 timer-measures a predetermined rejection delay time Tx from the time point t12, reads the NG1, OK, or NG2 signal, which is the determination result from the inspection control unit 41 at the time-up time point t13 when the rejection delay time Tx elapses, and outputs a rejection command RJ1 or RJ2 corresponding to the determination result as the discharge command signal, or executes the rejection control to output none of the NG1 signal or the NG2 signal in response to the OK signal and issues an OFF command signal to pass the article to the conveyor unit 14 side through a rear stage.

In FIG. 1 and other drawings, a transport speed in the acceleration section is represented by V, a transport speed in the inspection section is represented by V1, and a transport speed in the rejection section is represented by V2. The speeds V, V1, and V2 are equal to each other or the transport speed on the downstream side is set to be equal to or higher than the transport speed on the upstream side (V=V1 or V≤V1, V1=V2 or V1≤V2). In addition, in FIG. 5, the transport time corresponding to the article length Lw at the transport speed V1 in the inspection unit 20 is represented by Tw1 (=Lw/V1), and the transport time corresponding to the article length Lw at the transport speed V2 in the rejection unit 30 is represented by Tw2 (=Lw/V2). Hereinafter, unless the speeds V1 and V2 are particularly designated, the transport speed V2 in the rejection section is simply referred to as the transport speed V. In addition, unless the transport time Tw1 is particularly designated, the latter transport time Tw2 is simply referred to as the transport time Tw.

As illustrated in FIG. 4, the inspection control unit 41 is specifically configured to include, for example, a sampling circuit 44, weight calculation means 45, determination means 46, a determination result memory 47, a measurement time management timer 48, and an article type registration memory 49, and the rejection control unit 42 is configured to include, for example, a delay time management timer 53 (delay time management means) and a rejection command output unit 55.

Here, the sampling circuit 44 is a circuit that closes a switch 44a at a predetermined measurement timing in response to the article detection signal d1 when the detection signal d1 of the carrying-in article is received from the inspection article detection sensor 15, and the measurement timing is set according to a stability waiting time ts (see FIG. 5) from the start of carrying the article W onto the conveyor unit 12 to a time when the weight measurement signal is stabilized.

The weight measurement signal after the stability waiting time ts has elapsed is input to the weight calculation means 45 via the switch 44a, and the weight calculation means 45 calculates a weight value of the carrying-in article W by an average calculation or the like.

The weight calculated by the weight calculation means 45 is taken in as the measurement weight by the determination means 46, and the determination means 46 compares the weight with a preset allowable weight range, and outputs a determination signal corresponding to the determination result. The determination means 46 may be configured to input the previous stage inspection signal from the previous stage detector and output a comprehensive determination result.

In a case where the determination signal output from the determination means 46 is output including the previous stage inspection signal, for example, the determination signal can be a 4-bit determination signal as illustrated in FIG. 5, and when the previous stage inspection signal is OK, for example, the first bit is “0”, and the determination result for the weight can be known from the bit position of “1” in the remaining three bits.

For example, the 4-bit determination signal is a signal for requesting the rejection unit 30 to perform one article discharge operation of jetting the compressed air from one of the air nozzles 31A and 31B for a predetermined operation time in a case where “1” is present in the second bit, requesting the other article discharge operation of jetting the compressed air from the other of the air nozzles 31A and 31B for a predetermined operation time in a case where “1” is present in the third bit, and requesting holding to the non-discharge side (pass side) or returning to the non-discharge side in which the compressed air is not jetted from any one of the air nozzles 31A and 31B in a case where “1” is present in the fourth bit.

In a case where “1” is present in the first bit, although not illustrated in FIG. 5, as a determination of NG due to occurrence of an abnormality or a defect on the upstream side of the inspection unit 20, it is possible to request the article discharge operation of causing any one or both of the air nozzles 31A and 31B to jet the compressed air.

The determination signal output from the determination means 46 is sequentially stored in the determination result memory 47. The determination result memory 47 is configured by, for example, a first-in-first-out (FIFO) memory, and here, a plurality of determination signals can be stored in a sequential determination order while updating a pointer of a write-in address by a bit signal of “1” that is always included in the determination signal.

The measurement time management timer 48 is a delay timer that constitutes delay means of the determination result output together with the determination result memory 47, and has a timer function of delaying the timing of the determination signal output from the determination means 46 by a predetermined inspection time Tp from the carry-in detection time point to of the article W by the inspection article detection sensor 15.

The predetermined inspection time Tp set in the measurement time management timer 48 is set for each article type within a time range in which the article W is carried into the conveyor unit 12 of the inspection unit 20 from a time point at which the article W is detected by the inspection article detection sensor 15 and all or a part of the weight of the article W is input as a load to the weighing unit 22, based on, for example, the inspection unit passing time (L/V) of the centroid of the article W calculated based on the transport speed V of the article W and a device length L (see FIG. 2) of the inspection unit 20, and is set as a delay time including a time equal to or longer than a certain time required for weighing, at least a time in which the centroid of the article W moves on the transport passage surface of the conveyor unit 12 while the article W is supported only by the conveyor unit 12 of the inspection unit 20.

As described above, the control unit 40 has the measurement time management timer 48 that manages the inspection time Tp from the time point to when the remarkable point for specifying the article W, for example, the front end Eh of the article W illustrated in FIG. 1 is detected by the inspection article detection sensor 15 to the time when the inspection result of the inspected article W in the inspection unit 20 is output from the determination means 46, as a first delay time.

Here, the determination result memory 47 updates the pointer of the write-in address by the bit signal of “1” which is always included in the determination signal from the determination means 46, and updates the pointer of the read-out address each time the output from the delay time management timer 53 of the rejection control unit 42 is received. In addition, the read-out of the determination result by the determination means 46 from the determination result memory 47 is executed by the rejection command output unit 55 of the rejection control unit 42, and a determination result signal is output from the determination result memory 47 to the rejection command output unit 55 when the read-out is executed.

When a predetermined setting request Rqm for requesting a specific operation mode such as the setting of the article type is made from the display operation unit 43 and a plurality of main parameters for defining inspection conditions are set together with the product name or number (for example, “A008” in FIG. 4) for specifying the article type in the specific operation mode, the article type registration memory 49 stores, in the stored parameter, at least the distance Lrj from the rejection article detection position (second detection position) by the rejection article detection sensor 17 to the upstream end of the discharge bias section Za by the air nozzle 31A on the upstream side, the length Lt from the front end Eh of the article W to the predetermined essential pressurization point Ep, and the transport speed V2 of the conveyor unit 13 of the rejection unit 30. The length Lt may be registered as a length (Lw−Lt) from the rear end Et of the article W to the predetermined essential pressurization point Ep.

Here, the length Lt from the front end Eh of the article W to the predetermined essential pressurization point Ep is set as a parameter for the rejection control as the transport time Lt/V corresponding to the transport speed V2, and in a case where it is clear that the centroid position of the article W of the discharge target is biased in a specific direction (one side in the front and rear of the transport direction) with respect to the center Ec of the length Lw (=Tw·V) in the transport direction based on the detection information of the rejection article detection sensor 17 from a storage form or a shape of the contents of the article W, or the pressure receiving center position by the wind pressure in the discharge direction due to the blowing of the compressed air is biased in a specific direction from the center Ec of the length in the transport direction, the length Lt is set to a value different from the transport time (Tw/2) corresponding to the apparent centroid position Ec of the article W, and in other cases, the length Lt is set to a value equal to the transport time (Tw/2) corresponding to the centroid position of the article W.

The length Lt from the front end Eh of the article W to the predetermined essential pressurization point Ep means a transport distance from a time when the inspected article W that has entered the rejection section Z2 starts to enter the discharge bias region Za in front of the air nozzle 31A until the pressure-receiving area of the wind pressure generated by the compressed air increases to a degree at which the article W can be discharged, and can automatically adjust a timing at which the wind pressure load that is valid at a time when the compressed air is started to be jetted from the air nozzle 31A to an optimum side.

For the discharge bias section Za of the air nozzle 31A, the rejection delay time Td=(Tx+Tw) from the time point t11 when the front end Eh of the inspected article W enters the rejection section Z2 and is detected by the rejection article detection sensor 17 until the essential pressurization point Ep starts to enter the discharge bias region Za in front of the air nozzle 31A can be calculated as a transport distance (Lrj+Lt)/transport speed V2. In addition, the discharge bias section Zb of the air nozzle 31B on the downstream side is the transport time until the inspected article W starts to enter the discharge bias region Zb in front of the air nozzle 31B. Therefore, the rejection delay time Td can be calculated as the transport distance (Lrj+Lnp+Lt)/transport speed V2, and the transport time Lnp/V2 of the nozzle pitch Lnp is added.

When an input (for example, a plus (+) or a minus (−)) is performed to specify a bias direction (whether a front end side or a rear end side) from the center Ec of the length Lw of the article W in the transport direction, the length Lt from the front end Eh of the article W stored in the article type registration memory 49 to the predetermined essential pressurization point Ep is automatically set as a value corresponding to an adjustment amount α (time) of timing of a minimum deviation amount as a default. The length Lt is set to (Tw/2)−α from the front end Eh in a case of the essential pressurization point Ep on the front side in the transport direction, and is set to correspond to (Tw/2)+α from the front end Eh in a case of the essential pressurization point on the rear side in the transport direction. In this case, the adjustment amount α of the timing is set in advance as an adjustment time n·α (n is a natural number) suitable for stepwise adjustment of the blowing timing of the compressed air, and in a case where the bias of the centroid with respect to the center of the length Lw in the transport direction occurs depending on the type of the article W, the adjustment amount α may be set to the adjustment amount n·α by stepwise adding the adjustment amount α according to the degree of the magnitude of the deviation amount. Further, the essential pressurization point Ep that is converted in the number of multiple times the minimum adjustment time based on the centroid of the net product in the container such as the packaging box, and the like may be set to be close to the pressurization point of the optimum calculation value.

In a case where it is clear in appearance of the article W that the pressure receiving center point of the wind pressure from the side of the article W during transport is outside the center of the length in the transport direction based on the detection information of the rejection article detection sensor, a discharge force may be stably secured by setting the essential pressurization point Ep on the side of the center of the received pressure of the wind pressure by effectively receiving the pressure of the wind pressure.

That is, the display operation unit 43 and the article type registration memory 49 configure the pressurization point setting means for setting the essential pressurization point Ep of the article W for each type of the article W as the transport time Lt/V (or (Lw−Lt)/V from the rear end Et) corresponding to the distance Lt and the transport speed V in the transport direction of the article W from any one end of the article W in in the transport direction, for example, from the front end Eh, when the discharge force to the outside of the rejection transport passage by the compressed air is applied from the air nozzle 31A or/and 31B to the article W.

On the other hand, the delay time management timer 53 of the rejection control unit 42 has a management function of setting and timer-measuring the rejection delay time Td, which is set using the delay time (Tw+Tx) from the detection time point t11 when any one end of the article W, for example, the front end Eh is detected by the rejection article detection sensor 17 to a time when the essential pressurization point Ep of the article enters the discharge bias section Za, based on the registration information of the article type registration memory 49, and has a function of the delay time management means for outputting the output signal t13 for notifying the elapsed time of the rejection delay time Td at the time-up time point t13 when the rejection delay time Td elapses from the detection time point t11 to the determination result memory 47 to update the pointer of the read-out address, and outputting the output signal t13 to the rejection command output unit 55. In a case where the length Lt is registered in the article type registration memory 49 as the length (Lw−Lt) from the rear end Et of the article W to the predetermined essential pressurization point Ep, the delay time management timer 53 sets and timer-measures the rejection delay time Td that is set to be the same value as the delay time Tx using the delay time Tx from the detection time point t12 when the rear end Et of the article W is detected by the rejection article detection sensor 17 to a time when the essential pressurization point Ep of the article enters the discharge bias section Za. It is needless to say that the delay time (Tw+Tx) is a speed value ((Lrj+Lt)/V) obtained by dividing the transport distance (Lrj+Lt) until the front end Eh of the article W is transported in the distance Lrj from the detection position by the rejection article detection sensor 17 to the upstream end of the discharge bias section Za by the air nozzle 31A on the upstream side and the essential pressurization point Ep reaches the upstream end of the discharge bias section Za, by the rejection transport time V2. Therefore, the rejection delay time Tx can be calculated by an equation of (Lrj+Lt)/V−Tw.

In addition, the rejection command output unit 55 outputs the rejection command signal RJ1, RJ2, or OFF corresponding to the determination result NG1, NG2, or OK of the determination means 46 to the air supply control mechanism unit 35 of the rejection unit 30 for a predetermined command time Tw′ from the time-up time point t13 of the delay time management timer 53, drives to open the corresponding electromagnetic valve 32A or/and 32B when outputting the rejection command signal RJ1 or/and RJ2, and causes to jet the compressed air from the corresponding air nozzle 31A or/and 31B.

In the present embodiment, one end of the article W in the transport direction can be set as the rear end Et of the article W in the transport direction. In this case, the delay time management timer 53 manages the rejection delay time set by using the delay time Tx from the detection time point t12 when the rear end Et of the article W in the transport direction is detected by the rejection article detection sensor 17 to the time when the essential pressurization point Ep of the article W enters the discharge bias section Za in the rejection transport passage.

In this case, if the timing signal for notifying the elapse of the transport time Tw (time from the detection time point t11 to the detection time point t12) corresponding to the actual measured length of the article W is supplied to the rejection command output unit 55 from the time-up time point t13 of the delay time management timer 53, the rejection command output unit 55 can control the command time Tw′ of the rejection command signal to a sufficient time of about the article length corresponding time Tw according to the article length corresponding time Tw from the first detection time point t11 when the front end Eh of the article W in the transport direction is detected by the rejection article detection sensor 17 to the second detection time point t12 when the rear end Et of the article W in the transport direction is detected by the rejection article detection sensor 17.

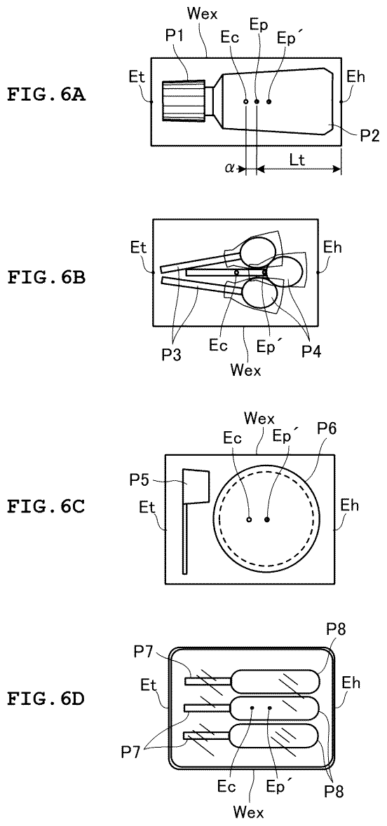

Further, as illustrated in FIG. 6A, in a case where the article W is stored in a container Wex, such as a predetermined-shaped packaging box, having a predetermined-shaped net product having a weight larger than the weight of the container Wex, for example, a tube product P2 with a cap P1 containing a paste substance illustrated in FIG. 6A, and the centroid Ep′ of the net product P2 is deviated from the center position Ec of the article W in the transport direction, the length Lt from the front end Eh of the article W to the predetermined essential pressurization point Ep is set in the article type registration memory 49 as the pressurization point setting means as described above, so that the essential pressurization point Ep of the article W can be set to be closer to the centroid position Ep′ (see FIGS. 6A to 6D) side of the net product in the article length Lw than the center Ec of the article length Lw in the transport direction. In FIG. 6A, the adjustment amount α is set to be smaller than the distance between the center Ec of the article length Lw and the centroid Ep′ of the net product P2, but the adjustment amount α can be brought closer to n times (for example, two times) by resetting or changing the setting. In a case where the net product in the container Wex such as the packaging box of the article W is the candy and other confectionery P4 with the rod P3 for gripping as illustrated in FIG. 6B, in a case where the net product is the product P6 with the tool P5 for product taking-out or can opening as illustrated in FIG. 6C, and in a case where the net product is the food P8 such as the frankfurter or the grilled meat with the rod or skewer P7 for gripping as illustrated in FIG. 6D, the same applies.

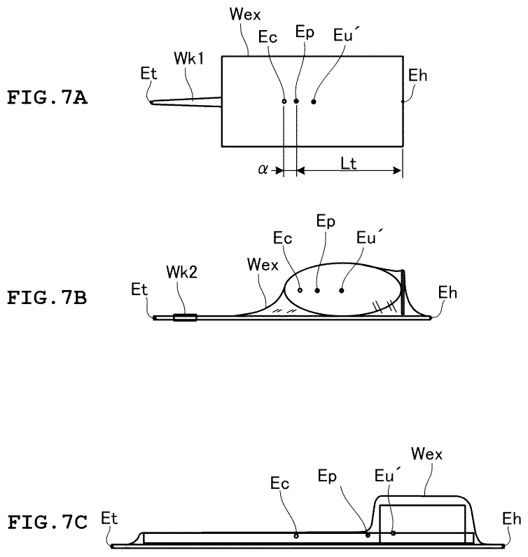

Further, as illustrated in FIG. 7A, in a case where the diagram center position Eu′ of the projection diagram of the product form of the article W with the protrusion portion Wk for hanging or gripping, as viewed in the discharge bias direction by the compressed air from the air nozzle 31A or/and 31B of the rejection unit 30 is deviated from the center position Ec of the article in the transport direction, the essential pressurization point Ep of the article W can be set to be closer to the diagram center position Eu′ side of the projection plane shape as viewed in the discharge bias direction than the center Ec of the article length Lw in the transport direction, in the article type registration memory 49 as the pressurization point setting means, as described above. In FIG. 7A, the adjustment amount α is set to be smaller than the distance between the center of the diagram center position Eu′ and the center Ec of the article length Lw. However, the adjustment amount α can be made closer to n times (for example, two times) the adjustment amount α by resetting or changing the setting. In a case where the projection diagram as viewed in the discharge bias direction by the compressed air in the container Wex such as a packaging box of the article W is packaged with a support plate with a window Wk2 for hanging or gripping and a wrapping material in a product form in which the weight portion is positioned on the lower end side as illustrated in FIG. 7B, and in a case where the product form is a product form in which a product with a handle (which may be a plurality of products) or a food with a rod is packaged with a base sheet and a transparent resin case as illustrated in FIG. 7C, the same applies.

In the present embodiment, as described above, the article inspection device includes the air jet type rejection unit 30 (discharge mechanism unit) that responds to the input of the rejection signal RJ1, RJ2, or OFF and discharges the inspected article W in the predetermined rejection section 22 to the outside of the transport passage according to the inspection result of the inspection unit 20, and the control unit 40 that has the inspection control unit 41 and the rejection control unit 42. In the article inspection device, in a case where it is clear that the centroid position of the article W of the discharge target is biased in the specific direction (one side in the front and rear of the transport direction) with respect to the center Ec of the length Lw (=Tw·V) in the transport direction based on the detection information of the rejection article detection sensor 17 from the storage form or shape of the contents of the article W, or the pressure receiving center position Eu′ of the discharge force (wind pressure load) due to the blowing of the compressed air is biased in the specific direction from the center Ec of the length in the transport direction, it is set to a value different from the time (Tw/2) corresponding to the apparent centroid position of the article W, and in other cases, it is set to the value (Tw/2) corresponding to the centroid position of the article W.

Then, the delay time management timer 53 manages the rejection delay time Td set in advance by using the delay time (Tw+Tx) or the delay time Tx from the detection time point t11 or t12 when the front end Eh or the rear end Et of the article W is detected by the rejection article detection sensor 17 until the essential pressurization point Ep of the article W enters the discharge bias section Za, and the rejection command output unit 55 inputs the rejection command signal Rj1, Rj2, or OFF to the rejection unit 30 according to the inspection result in the inspection unit 20 from the time-up time point t13 of the delay time management timer 53 by a predetermined command time Tw′.

Next, operations will be described.

In the article inspection device 1 of the present embodiment configured as described above, when the article W of the inspection target is sequentially carried in from the conveyor unit 11 on the previous stage side to the inspection unit 20 side at a predetermined transport pitch and the transport speed V, if each article W is detected by the inspection article detection sensor 15 for carrying-in detection on the entrance side of the inspection section Z1, the measurement is performed by the weighing unit 22 according to the article detection signal d1, the article weight is calculated by the weight calculation means 45, and the determination signal corresponding to the determination result by the determination means 46 is stored in the determination result memory 47 in order based on the output of the measurement time management timer 48 that notifies that the predetermined inspection time Tp has elapsed from the time point to of carrying-in of the article W and the signal information included in the determination signal.

Further, the determination result for each article stored in the determination result memory 47 is read out from the determination result memory 47 and outputs to the rejection command output unit 55 at the time point t13 when the rejection delay time Td has elapsed from the second detection time point t12 at which the rear end Et of the article W in the transport direction is detected by the rejection article detection sensor 17, according to the output of the delay time management timer 53.

When the rejection command from the rejection command output unit 55 is the ON signal of the discharge command RJ1 or/and RJ2, the electromagnetic valve 32A or/and 32B of the air supply control mechanism unit 35 of the rejection unit 30 is driven to be opened, and the compressed air is jetted from the air nozzle 31A or/and 32B according to the occurrence time point t13 of the rejection command and the holding time Tw′ from the occurrence time point t13. Therefore, the article W being transported is biased in the discharge direction to the outside of the transport passage by the wind pressure received from the side surface, and the article W is discharged to the outside of the transport passage while being blown away or slipping by the wind pressure load.

In addition, when the rejection command from the rejection command output unit 55 is the OFF signal of RJ1 and/or RJ2, the electromagnetic valve 32A and/or 32B of the air supply control mechanism unit 35 of the rejection unit 30 is held in the closed state. Therefore, the compressed air is not jetted from the air nozzle 31A and/or 32B, and the article W in which the article W that has entered the specific discharge bias section Za and/or Zb on the conveyor unit 13 is transported is not subjected to the wind pressure received from the side surface.

Therefore, when the rejection command from the rejection command output unit 55 is the OFF signal of both the RJ1 and the RJ2, both the electromagnetic valves 32A and 32B are held in the closed state, and thus both the air nozzles 31A and 31B do not jet the compressed air, and the article W is in the rejection state of passing through the downstream side without being subjected to the wind pressure from the side surface to the outside of the transport passage in the specific discharge bias sections Za and Zb.

As described above, in the present embodiment, a predetermined setting request Rqm for requesting the specific operation mode is made by the display operation unit 43 prior to such a normal inspection and rejection operation, and the main parameters are set in the specific operation mode such as a case of registering an article type. Then, in this case, the predetermined inspection time Tp is automatically set by the inspection control unit 41 based on the main parameters of the inspection unit 20, and the rejection delay time Td from the second detection time point t12 by the rejection article detection sensor 17 is automatically set by the delay time management timer 53 of the rejection control unit 42.

That is, the delay time management timer 53 sets the rejection delay time Td set by using the delay time (Tw+Tx) or the delay time Tx until the essential pressurization point Ep of the article W enters the discharge bias section Za from the detection time point t11 or t12 when the front end Eh or the rear end Et of the article W is detected by the rejection article detection sensor 17.

Further, when the operator is required to input a sample of the article W for which the article type registration is completed to the article inspection device 1 by the display operation unit 43, and the sample of the article W is input, the front end Eh of the article W is detected by the inspection article detection sensor 15, and then the weight inspection is performed by the inspection unit 20 within the predetermined inspection time Tp, the inspected article W is carried in on the conveyor unit 13 of the rejection unit 30, and the article W is detected by the rejection article detection sensor 17, the appropriateness of the automatically set rejection delay time Td is confirmed from the detection time point t12, and the resetting or setting change process of adding the adjustment amount α is executed as necessary.

Thereafter, when the normal operation in which the weight inspection and the rejection process of the article W are executed is started, each time each article W is detected by the rejection article detection sensor 17, the timer measurement of the rejection delay time Td by the delay time management timer 53 is executed from t the second detection time point t12. When the time-up time point t13 is reached, a signal for notifying the elapsed time point t13 of the rejection delay time Td or a signal for notifying the holding time Tw′ of the rejection command for each article type is output to the determination result memory 47 and the rejection command output unit 55. Then, the rejection command signal Rj1, Rj2, or OFF corresponding to the inspection result in the inspection unit 20 is transmitted from the rejection command output unit 55 to the air supply control mechanism unit 35 of the rejection unit 30 for a certain command time or the predetermined command time Tw′.

As described above, in the present embodiment, the essential pressurization point Ep of the article W is set in advance in association with the information on the article type as the transport time Lt/V corresponding to the distance Lt and the transport speed V in the transport direction from any one end of the article W in the transport direction, for example, the front end Eh. Then, when the transport time Tw corresponding to the length of the article W in the transport direction elapses from the first detection time point t11 when the front end Eh of the article W to be discharged is detected by the rejection article detection sensor 17, the second detection time point t12 when the rear end Et is detected is reached, the rejection delay time Td until the delay time Tx is elapsed until the essential pressurization point Ep enters the discharge bias section Za from the second detection time point t12, or the rejection delay time Td until the delay time Tw+Tx is elapsed until the essential pressurization point Ep enters the discharge bias section Za from the first detection time point t11 is elapsed. When the delay time management timer 53 is timed up, the rejection command output unit 55 inputs the rejection command signal to the air supply control mechanism unit 35 of the rejection unit 30 from the time point t13 for the predetermined command time Tw′.

Therefore, in a case where the centroid position Ep′ of the net product of the discharge target article W is biased in the specific direction with respect to the center Ec of the length Lw in the transport direction based on the detection information of the rejection article detection sensor 17, in a case where the pressure receiving center position Eu′ of the discharge force (wind pressure load) due to the blowing of the compressed air is biased in the specific direction from the center Ec of the length Lw in the transport direction, or the like, the essential pressurization point Ep at which the bias direction and the adjustment amount α of the minimum timing can be specified is set. Therefore, the timing of blowing air for biasing the transport article W of the discharge target to the discharge direction from the side surface can be easily and accurately set, and the stable discharge operation of the article W can be performed without reducing the productivity.

In addition, in the present embodiment, any one end of the article W in the transport direction is the rear end Et of the article W in the transport direction, the delay time management timer 53 manages the rejection delay time Td set in advance by using the delay time Tx from the second detection time point t12 when the rear end Et of the article W in the transport direction is detected by the rejection article detection sensor 17 to a time when the essential pressurization point Ep of the article W enters the discharge bias section in the rejection transport passage, and the rejection command output unit 55 controls the command time Tw′ of the rejection command output unit 55 in accordance with corresponding time Tw to the article length from the first detection time point t11 when the front end Eh of the article W in the transport direction is detected by the rejection article detection sensor 17 to the second detection time point t12 when the rear end Et of the article W in the transport direction is detected by the rejection article detection sensor 17. Therefore, the command time Tw′ of the rejection command signal can be accurately controlled according to the size of the article W.

Further, in the present embodiment, in a case where the article W stores a predetermined-shaped net product having a weight larger than a weight of a predetermined container in the predetermined-shaped packaging box or other containers, and the centroid Ep′ of the net product is deviated from the center position Ec of the article W in the transport direction, the article type registration memory 49 as the pressurization point setting means can set the length Lt, the transport speed V2, and the like as the setting parameters for each article type in addition to the above-described distance Lrj based on the specification of the rejection unit 30, and can set the essential pressurization point Ep of the article W closer to the centroid Ep′ side of the net product in the article length Lw than the center Ec of the article length Lw in the transport direction based on the set parameter values.

Therefore, it is possible to specify a direction in which the centroid Ep′ of the net product is deviated with respect to the apparent centroid Ec of the article W or the transport time Tw/2 corresponding thereto based on the detection information of the rejection article detection sensor 17 from the position information of the essential pressurization point Ep. Therefore, at least the direction in which the timing of the blowing of the compressed air with respect to the apparent centroid Ec of the article W is to be adjusted is specified, and the blowing timing of the air biasing the transport article W of the discharge target in the discharge direction from the side surface can be easily and accurately set.

In addition, in the present embodiment, even in a case where the diagram center position Eu′ of the projection diagram of the article W as viewed in the discharge bias direction by the compressed air from the air supply control mechanism unit 35 of the rejection unit 30 is deviated from the center position Ec of the article W in the transport direction, the article type registration memory 49 as the pressurization point setting means can set the length Lt, the transport speed V2, and the like as the setting parameters for each article type, in addition to the distance Lrj based on the specification of the rejection unit 30, and can set the essential pressurization point Ep of the article W to be closer to the diagram center Eu′ side of the projection plane shape as viewed in the discharge bias direction than the center Ec of the article length in the transport direction, based on the set parameter values. Therefore, at least the direction in which the timing with respect to the timing of the blowing of the apparent compressed air of the article W is to be adjusted is specified, and the blowing timing of the air biasing the transport article W of the discharge target in the discharge direction from the side surface can be easily and accurately set.

As described above, in the article inspection device 1 of the present embodiment, the air supply control mechanism unit 35 of the rejection unit 30 has the rejection article detection sensor 17 that is disposed on the entrance side of the predetermined rejection section Z2, the article type registration memory 49 as the pressurization point setting means that sets the essential pressurization point Ep of the article W when the discharge force to the outside of the transport passage by the compressed air is applied from the air supply control mechanism unit 35 of the rejection unit 30, for each article type of the article W, as the transport time Lt/V corresponding to the distance Lt in the transport direction from the front end Eh of the article W in the transport direction and the transport speed V (or as the transport time (Lw−Lt)/V corresponding to the distance (Lw−Lt) from the rear end Et to the front side in the transport direction and the transport speed (V)), the delay time management timer 53 that manages the rejection delay time Td set from the detection time point t11 or the detection time point t12 when the front end Eh or the rear end Et (any one end) of the article W is detected by the rejection article detection sensor 17 until the essential pressurization point of the article W enters the discharge bias section Za, using the delay time (Tw+Tx) or the delay time Tx, and the rejection command output unit 55 that inputs the rejection command signal RJ1, RJ2, or OFF to the air supply control mechanism unit 35 of the rejection unit 30 in accordance with the inspection result in the inspection unit 20 from the time-up time point t13 of the delay time management timer 53, by the predetermined command time Tw′.

Then, when the essential pressurization point Ep of the article W is set in advance as, for example, the transport time Lt/V in association with the information on the article type, the rejection delay time Td set by using the delay time Tx from the detection time point t12 until the essential pressurization point Ep of the article W enters the discharge bias section Za elapses, and the delay time management timer 53 reaches the time-up, the rejection command output unit 55 inputs the rejection command signal Rj1, Rj2, or OFF to the air supply control mechanism unit 35 of the rejection unit 30 from the time point t13 by the predetermined command time Tw′.

Therefore, in a case where the centroid position Ep′ of the article W of the discharge target is biased in the specific direction with respect to the center Ec of the length in the transport direction based on the detection information of the rejection article detection sensor 17, in a case where the pressure receiving center position Eu′ of the discharge force due to the blowing of the compressed air is biased in the specific direction from the center of the length in the transport direction, or the like, the essential pressurization point Ep at which the bias direction and the adjustment amount α of the minimum timing can be specified is set. Therefore, the timing of blowing air for biasing the transport article W of the discharge target to the discharge direction from the side surface can be easily and accurately set, and the article inspection device capable of performing a stable discharge operation of the article W is obtained.

As a result, according to the present embodiment, it is possible to provide a rejection device and an article inspection device capable of easily and accurately setting the timing of blowing air for biasing the transport article W of the discharge target to the discharge direction from the side surface, and capable of performing the stable discharge operation of the article W without reducing the productivity.

In the above-described embodiment, any one end that is the remarkable point for specifying the position of the essential pressurization point Ep of the article W is the front end Eh. However, as described above, the position of the essential pressurization point Ep can be specified by using the rear end of the article W as the remarkable point. In addition, as described above, the output time of the rejection command signal from the rejection command output unit 55 to the air supply control mechanism unit 35 can be increased or decreased in consideration of the workpiece transport time Tw obtained by dividing the length Lw of the article W in the transport direction by the transport speed V, or the rejection command signal for a certain time may be output each time the article W passes through each of the discharge bias sections Za and Zb, and the like, instead of such a variable control.

In addition, the article inspection method of the inspection unit 20 is not limited to the method in which the weighing unit 22 performs weighing or measurement, and it is obvious that the article inspection method may be performed by various other article inspection devices such as foreign matter detection, out-of-stock inspection, packaging defect, and appearance inspection, and thus the main setting parameters may also change. However, in a case where the process of the article inspection in the inspection unit 20 can be performed in a relatively short period and the transport speed is relatively high, the present invention can be effectively applied.

In addition, in the present example, the air nozzles 31A and 31B are illustrated in side-by-side arrangement in the same direction for convenience of illustration and are separated by the predetermined nozzle pitch Lnp in the transport direction. However, the air nozzles 31A and 31B may be disposed in a facing arrangement in which the jetting directions of the compressed air intersect with each other or in a facing arrangement in which the blowing ports are disposed to face the conveyor unit 13 side and are separated by the predetermined nozzle pitch Lnp in the transport direction, and the like. The jetting directions of the compressed air may be set to be inclined to the downstream side with respect to the article transport direction. Further, by using the air pressure, it is also possible to perform suction bias from the vertically upper side or push-up bias from the lower side with respect to the article W in the discharge bias sections Za and Zb.

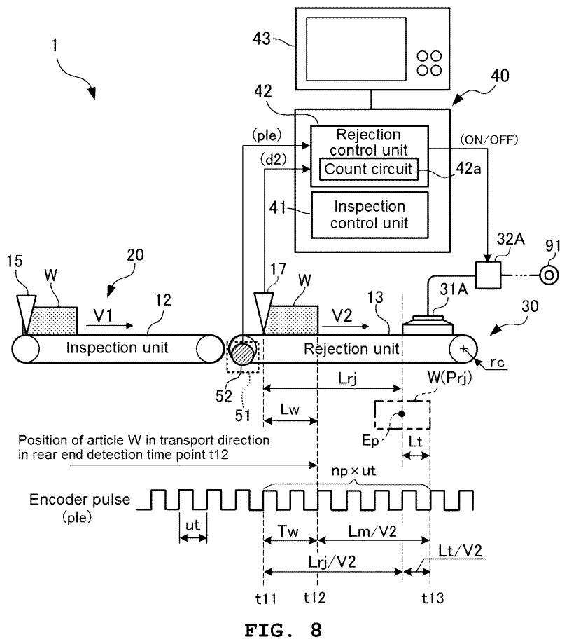

Further, the rejection delay time management means in the present invention is configured as the delay time management timer 53 in the above-described embodiment, but instead of the configuration, the rejection delay time can be configured to be managed based on a transport distance. That is, as illustrated in FIG. 8, it is possible to provide means (delay time corresponding distance calculation means) that detects the position of the article W in the transport direction (see FIG. 8) at the rear end detection time point t12 of the article W by the rejection article detection sensor 17 based on the output pulse ple of the rotary encoder 52 (encoder) that detects the rotational position, the displacement detection signal, or the control signal of the transport driving motor 51 of the conveyor unit 13, for example, the rotational angle displacement of the transport driving motor 51 in the predetermined angle unit, and then calculates the article transport distance Lm (delay time corresponding distance) corresponding to the rejection delay time is provided based on the number of output pulses and the resolution (number of pulses/rotation) of the rotary encoder 52, the driving radius rc of the conveyor belt, and the like. In addition, in this case, an incremental rotary encoder that outputs, for example, signals of an A phase and a B phase in which pulses rise at different phases and a signal of a Z phase in which pulses rise for each rotation can be used as the rotary encoder 52. In addition, in the delay time management means according to the present invention, the count circuit 42a is provided in the rejection control unit 42, which counts the output pulse ple of the rotary encoder 52 in addition to the rotary encoder 52 that detects the rotational displacement of the transport driving motor 51 driving the conveyor unit 13 of the transport unit 10 in units of a predetermined angle and outputs a detection pulse for each predetermined angle (predetermined pulse period ut) (may be a linear encoder that measures the moving distance of the belt surface) and takes in the article detection signal d2 of the rejection article detection sensor 17 as a clear request signal of the count value. The count value of the encoder output pulse in the count circuit 42a is cleared (reset) at the first detection time point t11 or the second detection time point t12, which is the rejection article detection time point, so that the rejection delay time Td after the rejection article detection time point t11 can be grasped as the transport distance (Lrj+Lt)/transport speed (V2) corresponding to the rejection delay time Td (=np×ut) based on the count value np of the encoder output pulse ple that is newly counted from the rejection article detection time point t11.

As described above, the article inspection device according to the embodiment of the present invention can provide a rejection device and an article inspection device capable of easily and accurately setting the blowing timing of the air that biases the transport article of the discharge target in the discharge direction from the side surface and stably performing the discharge operation of the article. The present invention is useful for a rejection device such as an air jet type in which an article is required to be discharged in a short time, and an article inspection device in which the rejection device is disposed as a rejection unit on a downstream side of an inspection unit that performs an article inspection.

### DESCRIPTION OF REFERENCE NUMERALS AND SIGNS

1: article inspection device

10: transport unit

11, 12, 13, 14: conveyor unit

15: inspection article detection sensor

17: rejection article detection sensor

20: inspection unit

21: weighing table

22: weighing unit (weight measuring unit)

30: rejection unit (discharge mechanism unit)

31A, 31B: air nozzle

32A, 32B: electromagnetic valve

33: air tank

34: filter regulator

35: air supply control mechanism unit (rejection drive control means)

36A, 36B: chute

40: control unit

41: inspection control unit

42: rejection control unit

42a count circuit

43: display operation unit

44: sampling circuit

44a: switch

45: weight calculation means

46: determination means

47: determination result memory

48: measurement time management timer

49: article type registration memory

51: transport driving motor

52: rotary encoder (encoder)

53: delay time management timer (delay time setting means, rejection delay time timer)

55: rejection command output unit (rejection command means)

91: air source

d1: detection signal (inspection article detection signal, first detection signal)

d2: detection signal (rejection article detection signal, second detection signal)

Ec: center (center of length of article in transport direction)

Eh: front end

Ep: essential pressurization point

Ep′ centroid (centroid position)

Et: rear end

Eu′: pressure receiving center position (diagram center position)

L: device length (length of inspection unit in transport direction)

Lm: article transport distance (delay time corresponding distance)

Lnp: inter-nozzle pitch

Lrj distance (distance from second detection position to upstream end of discharge bias section)

Lt: length (length from article front end to essential pressurization point)

Lw: article length (length of article in transport direction)

NG1, NG2: determination results (defective determination)

np: count value

OK: determination result (determination of good product)

P1: cap

P2: tube product (net product)

P3: rod (stick)

P4 candy and other confectionery

P5: can opening tool

P6: can product

P7: rod or skewer

P8: food

ple: output pulse

RJ1, RJ2: rejection command (discharge command)

t0: detection time point (carry-in detection time point, inspection article detection time point)

t11: detection time point (first detection time point, detection time point of the front end of the discharge article)

t12: detection time point (second detection time point, detection time point of rear end of discharge article)

t13: time point (elapsed time point, time-up time point, occurrence time point, output signal)

Td: rejection delay time

ts: stability waiting time

Tw, Tw1, Tw2: transport time (transport time corresponding to article length)

Tx: delay time (predetermined rejection delay time from second detection time point)

ut: predetermined pulse period

V, V1, V2: transport speed

Z1: inspection section (inspection transport passage)

Z2: rejection section (rejection transport passage)

Za, Zb: discharge bias section

α: adjustment amount (minimum adjustment time, minimal adjustment time)

What is claimed is:

1. A rejection device including a transport unit that transports an article and includes a rejection transport passage, and a discharge mechanism unit that responds to an input of a rejection command signal and discharges the article, which enters a specific discharge bias section in the rejection transport passage, to an outside of the rejection transport passage by compressed air, the rejection device comprising:
a rejection article detection sensor that is disposed on an entrance side of the rejection transport passage and detects the article;
pressurization point setting means for setting an essential pressurization point of the article when a discharge force to the outside of the rejection transport passage is applied from the discharge mechanism unit by the compressed air, based on a transport time corresponding to a distance and a transport speed from any one end of the article in a transport direction for each type of the article;
delay time management means for managing a rejection delay time that is set by using a delay time from a detection time point when the one end of the article in the transport direction is detected by the rejection article detection sensor to a time when the essential pressurization point of the article enters the discharge bias section, and;
rejection command means for inputting the rejection command signal to the discharge mechanism unit for a predetermined command time from a time-up time point of the delay time management means.

2. The rejection device according to claim 1, wherein
the one end of the article in the transport direction is a rear end of the article in the transport direction,
the delay time management means manages a rejection delay time set by using a delay time from a detection time point when the rear end of the article in the transport direction is detected by the rejection article detection sensor to a time when the essential pressurization point of the article enters the discharge bias section in the rejection transport passage, and
the rejection command means controls the command time of the rejection command signal in accordance with an article length corresponding time from a first detection time point when a front end of the article in the transport direction is detected by the rejection article detection sensor to a second detection time point when the rear end of the article in the transport direction is detected by the rejection article detection sensor.

3. The rejection device according to claim 1, wherein
the article stores a predetermined-shaped net product in a predetermined-shaped packaging box or other containers, the net product having a weight greater than a weight of the container, and a centroid of the net product is deviated from a center position of the article in the transport direction, and
the pressurization point setting means sets the essential pressurization point of the article to be closer to a centroid position side of the net product in an article length than a center of the article length in the transport direction.

4. The rejection device according to claim 2, wherein
the article stores a predetermined-shaped net product in a predetermined-shaped packaging box or other containers, the net product having a weight greater than a weight of the container, and a centroid of the net product is deviated from a center position of the article in the transport direction, and
the pressurization point setting means sets the essential pressurization point of the article to be closer to a centroid position side of the net product in the article length than a center of the article length in the transport direction.

5. The rejection device according to claim 1, wherein
a diagram center position of a projection diagram of the article as viewed in a discharge bias direction by the compressed air from the discharge mechanism unit is deviated from a center position of the article in the transport direction, and
the pressurization point setting means sets the essential pressurization point of the article to be closer to a diagram center position side of a projection plane shape as viewed in the discharge bias direction than a center of an article length in the transport direction.

6. The rejection device according to claim 2, wherein
a diagram center position of a projection diagram of the article as viewed in a discharge bias direction by the compressed air from the discharge mechanism unit is deviated from a center position of the article in the transport direction, and
the pressurization point setting means sets the essential pressurization point of the article to be closer to a diagram center position side of a projection plane shape as viewed in the discharge bias direction than a center of the article length in the transport direction.

7. The rejection device according to claim 1, wherein
the delay time management means has an encoder that detects a rotational angle displacement of a transport driving motor driving the transport unit in a predetermined angle unit and outputs a detection pulse for each predetermined angle, and a count circuit that counts an output pulse of the encoder and inputs a detection signal of the rejection article detection sensor, and
the rejection delay time is grasped based on a count value of the output pulse of the encoder after the detection time point when the one end of the article in the transport direction is detected by the rejection article detection sensor.

8. The rejection device according to claim 2, wherein
the delay time management means has an encoder that detects a rotational angle displacement of a transport driving motor driving the transport unit in a predetermined angle unit and outputs a detection pulse for each predetermined angle, and a count circuit that counts an output pulse of the encoder and inputs a detection signal of the rejection article detection sensor, and
the rejection delay time is grasped based on a count value of the output pulse of the encoder after the detection time point when the one end of the article in the transport direction is detected by the rejection article detection sensor.

9. An article inspection device comprising:
a transport unit that transports an article and includes a predetermined transport passage;
an inspection unit that inspects a predetermined quality state of the article being transported in a predetermined inspection section in the transport passage;
an air jet type discharge mechanism unit that responds to an input of a rejection command signal and discharges an article which is inspected in a predetermined rejection section in the transport passage to an outside of the transport passage in accordance with an inspection result in the inspection unit; and
a control unit that includes an inspection control unit controlling the inspection unit and a rejection control unit controlling the discharge mechanism unit, wherein
the discharge mechanism unit includes
a rejection article detection sensor that is disposed on an entrance side of the predetermined rejection section,
pressurization point setting means for setting an essential pressurization point of the article when a discharge force to the outside of the transport passage is applied from the discharge mechanism unit by compressed air, based on a transport time corresponding to a distance and a transport speed from any one end of the article in a transport direction for each type of the article,
delay time management means for managing a rejection delay time that is set by using a delay time from a detection time point when the one end of the article in the transport direction is detected by the rejection article detection sensor to a time when the essential pressurization point of the article enters a discharge bias section, and,
rejection command means for inputting the rejection command signal to the discharge mechanism unit for a predetermined command time from a time-up time point of the delay time management means in accordance with an inspection result in the inspection unit.

10. The article inspection device according to claim 9, wherein
the one end of the article in the transport direction is a rear end of the article in the transport direction,
the delay time management means manages a rejection delay time set by using a delay time from a detection time point when the rear end of the article in the transport direction is detected by the rejection article detection sensor to a time when the essential pressurization point of the article enters the discharge bias section in the transport passage, and
the rejection command means controls the command time of the rejection command signal in accordance with an article length corresponding time from a first detection time point when a front end of the article in the transport direction is detected by the rejection article detection sensor to a second detection time point when the rear end of the article in the transport direction is detected by the rejection article detection sensor.
